(19) United States
(12) Patent Application Publication
(10) Pub. No.: US 2021/0185984 A1
(43) Pub. Date: Jun. 24, 2021

(54) SYSTEMS AND METHODS OF MONITORING AND TRAINING DOGS AND DETERMINING THE DISTANCE BETWEEN A DOG AND A PERSON

(71) Applicants: Bruce G. Kania, Shepherd, MT (US); Anne Kania, Shepherd, MT (US); Frank M. Stewart, Bozeman, MT (US); Cory Mettler, Bozeman, MT (US)

(72) Inventors: Bruce G. Kania, Shepherd, MT (US); Anne Kania, Shepherd, MT (US); Frank M. Stewart, Bozeman, MT (US); Cory Mettler, Bozeman, MT (US)

(21) Appl. No.: 17/124,320

(22) Filed: Dec. 16, 2020

Related U.S. Application Data
(60) Provisional application No. 63/070,945, filed on Aug. 27, 2020.
(60) Provisional application No. 62/949,711, filed on Dec. 18, 2019.

(51) Int. Cl. A01K 27/00; A01K 15/02

(52) U.S. Cl. CPC A01K 27/001; A01K 15/023; A01K 27/009

(57) ABSTRACT

Exemplary embodiments of a system for monitoring a dog comprise a control unit including a transmitter configured to transmit periodic signals and a collar unit including a receiver configured to receive the periodic signals from the transmitter. The periodic signals comprise individual signals having different power levels such that the individual signals travel different distances depending on their respective power levels. The different power levels may comprise a high-power level, a medium-power level, a low-power level, and a minimum power level. The system determines a distance between the collar unit and the control unit by determining which of the individual signals is received by the collar unit. Systems and methods of training dogs and monitoring the distance between a dog and a person also are provided.

### CROSS-REFERENCE TO RELATED APPLICATIONS

This application is a non-provisional of and claims priority to and benefit of U.S. Patent Application Ser. No. 63/070,945, filed Aug. 27, 2020, and U.S. Patent Application Ser. No. 62/949,711, filed Dec. 18, 2019, each of which is hereby incorporated by reference in its entirety.

### FIELD OF THE DISCLOSURE

The following disclosure relates to devices, systems and methods of monitoring dogs as well as systems and methods for determining the distance between a dog and a person.

### BACKGROUND

There are many situations in which dog owners would like to let their dogs off leash but need the ability to keep the dogs close and/or have them return to them even when out of earshot. This is particularly important in the hunting context, where dogs are commonly used to hunt birds. There are two primary classes of bird hunting dogs: flushers and pointers. In general, flushers have been conditioned for millennia to stay relatively close. Pointers are, traditionally, allowed to range further.

The problem is that “relatively close” is not always within shotgun range. It can be difficult to keep a flushing dog within shotgun range. This is about 30 yards, or perhaps 40 for the best shooters. Birds typically flush another ten yards or so in front of the dogs. When you add reaction time to the mix, a bird may be fifty yards out before a shot is fired. Pointers range even further, and frequently flush while trying to point. The energy and intensity of the hunt often infects a good dog to the point where it does not always respond to normal training. This ultimately means that there will still be a training and conditioning period during which impeccable performance may be lacking.

Furthermore, hunting is very different than shooting. Shooting is essentially the control and management of a gun. Many shooters also hunt but are not much more effective at harvest of animals than average shooters. This is due in part to the distractions connected with dog management. To be effective at hunting, one's attention must be focused on a number of factors, including sound, sight, position in cover, position of other hunters including dogs, wind, level of cover, and dozens of other factors. There are numerous factors, all of which contribute to the hunt. Today the hunter that also is responsible for controlling his or her dog is the individual upon whom the hunt relies. If a dog messes up, the entire hunt party will frequently fail to even get a shot.

Some currently available collars provide a control option. The dog owner can send an audio tone that the dog learns to understand. Current training collars allow the owner to issue an audio tone, a single one, when the owner wants the dog to “turn” and come back. However, the dog will sometimes disregard the signal, or only return partially. In some currently available collars, three presses of a button can translate to three audio tones that a dog recognizes as a signal to “come back.” A “buzz” is an even more powerful signal, that means “come back now!” These are signals that, prior to electronic collars were communicated with whistles, although the whistle option never included any “buzz.” However, one drawback is that today every signal requires a human hand to activate. If dog management were hands free, the hunter responsible for dog performance would be more able to focus on the hunt. This would be more pleasurable and less disconcerting than having to manage a dog, or dogs, constantly while hunting.

Also, currently available hunting dog collars employ neutral and negative reinforcement/punishment stimulation to train and control hunting dogs. Today's collars rely on negative reinforcement, i.e., the “buzz.” A pervasive belief among hunting enthusiasts is that hunting dogs have been bred for eons to be strong willed and tenacious, so it is thought that forceful action must be employed to influence them.

However, numerous studies have demonstrated that positive reinforcement actually is more effective than negative reinforcement and punishment. Integration of positive reinforcement into training techniques, paired with dog collars that have evolved and now represent an effective means by which to signal a dog, will expedite training and result in less trauma for the dog and dog owner.

Generally speaking, the existing art of dog monitors falls into two categories: GPS-based and RSSI-based units. In the former, both the collar and base have GPS receivers which collect data from the GPS satellite network. The two units may use a radio transmission to communicate with each other. However, the radio signal is not being used to determine distance/location. Rather, the base sends its GPS coordinates to the collar via the radio communication. The collar compares the base's coordinates to its own coordinates, and the exact distance between the units is determined. The collar also sends its coordinates back to the base so that the user knows exactly where the collar is (both distance and heading/angle). This uses the radio technology to transmit data, which requires a lot of power.

In RSSI-based units, the base transmits a radio signal at a constant power setting. As the signal propagates away from the base, it loses strength. The collars receive that signal and measure the signal strength. The collar determines an exact distance from the base nearly as accurately as the GPS units. A dog that is within bounds will not activate a corrective indicator (i.e., an audio tone), but a dog that is out of bounds will activate a corrective indicator. In this art the base does not change its transmission power. A significant weakness of this art is that the collar assumes any degradation of the signal strength must be due to the distance between the collar and the base; if, however, the signal experiences an interference such as the dog (and therefore the collar) disappearing behind a hill, the collar is liable to assume a longer distance than actually separates the two units.

Accordingly, there is a need for a more effective, hands free dog management system. There also is a need for a system and method to keep dogs, particularly hunting dogs, close and/or have them return even when out of earshot. There is a need for a system and method for monitoring the distance between a dog and person. Finally, there is a need for a system and method that can provide both negative and positive reinforcement to keep a dog within a certain distance of a person.

### SUMMARY

The present disclosure, in its many embodiments, alleviates to a great extent the disadvantages of known dog monitoring devices by providing devices, systems and methods for monitoring the distance between a person and a dog. Disclosed embodiments further provide visual and/or audible or vibratory indication of the dog's distance to the person and an audible warning or electrical shock correction to the dog when the dog has exceeded a “maximum allowable distance” from the person.

Exemplary embodiments can also optionally provide positive reinforcement signals when the dog is within the designated zone or is returning from outside the zone. More particularly, disclosed systems incorporate a variety of forms of positive reinforcement to keep dogs within the “happy” zone. Advantageously, disclosed embodiments turn the tables, representing a reversal of standard design for control collars. It means that dog owners can take responsibility for both positive and negative reinforcement options.

Disclosed systems are hands free and can function both for hunters with hunting dogs and for lay people with pet dogs. A dog owner walking the family dog wouldn't have to worry about it darting out into traffic. That is because the zone control radius could be set on six feet. The system is designed to control a canine by keeping it within your prescribed safety zone, and to do so without your constant attention. Essentially, the unit represents a variation on the “heel” command.

For hunters, a primary goal is to keep a flushing dog within shotgun range. Typically, that would be about 30 yards, or perhaps 40 for the best shooters, but larger ranges are also enabled by the present disclosure. The system described herein will perform for both flushers and pointers. One goal of disclosed embodiments is to abbreviate the high energy and high calorie training experience that currently is associated with hunting dog training. Another application could be managing companion dogs. Keeping our canine companions nearby, without having to be constantly on alert for transgressions, would be a wonderful stress reliever. Disclosed embodiments can contribute to the peace of mind of countless dog owners.

Disclosed Mobile Zone Control (MZC) embodiments can be an incredibly valuable system for dog owners. They allow for much more carefree management of a “ruthless” puppy. A ruthless puppy is one who simply does not (yet) focus on reasonable rules of behavior. Frequently, such canines will simply “follow their nose.” In a hunting scenario they can be 300 yards into premier pheasant cover, disrupting countless birds, in the blink of an eye. This behavior could result in disaster for both dog and owner.

Exemplary embodiments of a system for monitoring a dog comprise a control unit including a transmitter configured to transmit periodic signals and a collar unit including a receiver configured to receive the periodic signals from the transmitter. The periodic signals comprise individual signals having different power levels such that the individual signals travel different distances depending on their respective power levels. The different power levels may comprise a high-power level, a medium-power level, a low-power level, and a minimum power level. The system determines a distance between the collar unit and the control unit by determining which of the individual signals are received by the collar unit.

In exemplary embodiments, the receiver receives an individual signal having a high-power level when a distance between the control unit and the collar unit is up to about 500 feet. The receiver may receive an individual signal having a medium-power level when a distance between the control unit and the collar unit is up to about 200 feet. The receiver may receive an individual signal having a low-power level when a distance between the control unit and the collar unit is up to about 100 feet. The receiver may receive an individual signal having a minimum-power level when a distance between the control unit and the collar unit is up to about 20 feet.

The periodic signals and individual signals may be RF pulses in some embodiments. In exemplary embodiments, when the receiver does not receive a periodic signal within a pre-determined time period the collar unit starts a clock. When the clock reaches a pre-determined time value the collar unit emits an audible warning. When the receiver receives a periodic signal the collar unit resets the clock. In exemplary embodiments, the collar unit is coupled to or integrated with a collar configured to be worn by a dog. The collar unit may emit an audible signal or electric shock when the dog exceeds a pre-determined maximum allowable distance from a person. Exemplary systems may further comprise a locate feature causing the collar unit to emit an audible signal.

An exemplary system for monitoring the distance between a dog and a person comprises a control unit including a transmitter configured to transmit signals and a collar unit including a receiver configured to receive the signals from the transmitter. The system determines the distance between the person and the dog by measuring the travel time of the signals between the control unit and the collar unit. The control unit provides an indication of the distance between the dog and the person. The collar unit is coupled to or integrated with a collar configured to be worn by a dog.

In exemplary embodiments, the system determines the distance between the person and the dog by measuring one-way travel time of the signals traveling from the control unit to the collar unit. The system may determine the distance between the person and the dog by measuring two-way travel time of the signals traveling from the control unit to the collar unit and back from the collar unit to the control unit. In exemplary embodiments, the collar unit provides negative reinforcement when the dog exceeds a pre-determined maximum allowable distance from a person and positive reinforcement when the dog stays within the pre-determined maximum allowable distance from the person.

Exemplary methods of monitoring a dog comprise transmitting a series of periodic signals from a base unit, receiving the periodic signals in a dog collar unit, and determining the distance between the dog collar unit and the base unit. The periodic signals may include a high-power signal traveling a first distance, a medium-power signal traveling a second distance shorter than the first distance, a low-power signal traveling a third distance shorter than the second distance, and/or a minimum-power signal traveling a fourth distance shorter than the third distance. The distance is determined by determining which of the high-power signal, medium-power signal, low-power signal and minimum-power signal are received by the dog collar unit.

In exemplary embodiments, it is determined that the distance between the dog collar unit and the base unit is between about 200 feet and about 500 feet when only the high-power signal is received by the dog collar unit. Exemplary methods determine that the distance between the dog collar unit and the base unit is between about 100 feet and about 200 feet when only the high-power signal and medium-power signal are received by the dog collar unit. Exemplary methods determine that the distance between the dog collar unit and the base unit is between about 20 feet and about 100 feet when only the high-power signal, medium-power signal, and low-power signal are received by the dog collar unit. Exemplary methods determine that the distance between the dog collar unit and the base unit is less than about 20 feet when the high-power signal, medium-power signal, low-power signal, and minimum-power signal are received by the dog collar unit.

Exemplary methods further comprise transmitting an acknowledgement signal from the dog collar unit to the base unit each time the dog collar unit receives a signal from the base unit. The dog collar unit may provide negative reinforcement when the dog exceeds a pre-determined maximum allowable distance from a person and positive reinforcement when the dog stays within the pre-determined maximum allowable distance from the person. Exemplary methods further comprise starting a clock when the dog collar unit does not receive a signal withing a pre-determined time period. Exemplary methods may further comprise emitting an audible warning when the clock reaches a pre-determined time value and resetting the clock when the dog collar unit receives a periodic signal.

Accordingly, it is seen that dog monitoring systems and methods are provided. These and other features of the disclosed embodiments will be appreciated from review of the following detailed description, along with the accompanying figures in which like reference numbers refer to like parts throughout.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a front view of an exemplary embodiment of a dog monitoring system in accordance with the present disclosure;

FIG. 2 is a schematic of an exemplary embodiment of a dog monitoring system in accordance with the present disclosure;

FIG. 3 is front view of an exemplary embodiment of a system and method of determining the distance between a dog and a person in accordance with the present disclosure;

FIG. 4 is a schematic of an exemplary embodiment of a system and method of monitoring a dog and determining the distance between a dog and a person in accordance with the present disclosure;

FIG. 5 is a schematic of an exemplary embodiment of a system and method of monitoring a dog and determining the distance between a dog and a person in accordance with the present disclosure;

FIG. 6 is a schematic of an exemplary embodiment of a system and method of monitoring a dog and determining the distance between a dog and a person in accordance with the present disclosure;

FIG. 7 is a schematic of an exemplary embodiment of a system and method of monitoring a dog and determining the distance between a dog and a person in accordance with the present disclosure;

FIG. 8 is a schematic of an exemplary embodiment of a system and method of monitoring a dog and determining the distance between a dog and a person in accordance with the present disclosure;

FIG. 9 is a schematic of an exemplary embodiment of a system and method of monitoring a dog and determining the distance between a dog and a person in accordance with the present disclosure;

FIG. 10 is a schematic of an exemplary embodiment of a system and method of monitoring a dog and determining the distance between a dog and a person in accordance with the present disclosure;

FIG. 11 is a process flow table showing an exemplary embodiment of a system and method of monitoring a dog and determining the distance between a dog and a person in accordance with the present disclosure;

FIG. 12 is a schematic of an exemplary embodiment of a system and method of monitoring a dog and determining the distance between a dog and a person in accordance with the present disclosure; and

FIG. 13 is a perspective view of an exemplary embodiment of a method of training a dog in accordance with the present disclosure.

### DETAILED DESCRIPTION

In the following detailed description of exemplary embodiments of the disclosure, reference is made to the accompanying drawings in which like references indicate similar elements, and in which is shown by way of illustration specific embodiments in which disclosed systems and devices may be practiced. These embodiments are described in sufficient detail to enable those skilled in the art to practice the embodiments, and it is to be understood that other embodiments may be utilized and that logical, mechanical, functional, and other changes may be made without departing from the scope of the present disclosure. The following detailed description is, therefore, not to be taken in a limiting sense, and the scope of the present disclosure is defined only by the appended claims. As used in the present disclosure, the term “or” shall be understood to be defined as a logical disjunction and shall not indicate an exclusive disjunction.

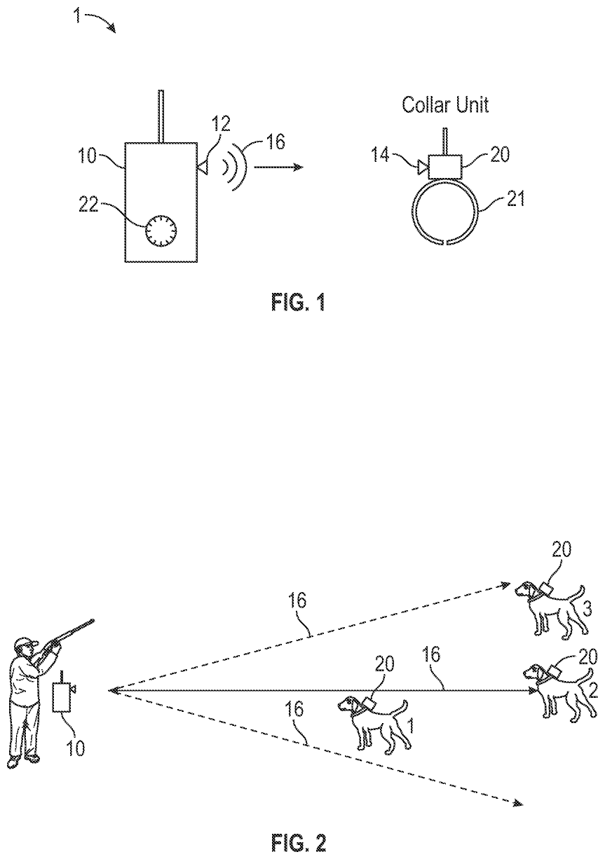

An exemplary embodiment of a system for monitoring a dog is shown in FIGS. 1 and 2 and operates as follows. The major components of the system 1 are a base unit or control unit 10 and a collar unit 20. The control unit 10 includes a mobile transmitter 12, which may be housed within the control unit or coupled thereto. The collar unit 20 includes a corresponding receiver 14. As with the transmitter 12, the receiver 14 may be located within the collar unit 20 or coupled to it. The collar unit 20 is configured to be coupled to, attached to, or integrated with a dog collar 21. The control or base unit 10 uses the radio transmitter 12 to send an encoded signal 16 to the receiver 14. These signals 16 are sent periodically and may be radio frequency (RF) pulses or any other type of transmittable signal.

In exemplary embodiments, the control unit 10 transmits a sequence of individual RF pulses 16 at regular intervals. As discussed in more detail herein, the multiple RF pulses 16 have different transmitted power levels and each may have a unique signature. The receiver 14 in the collar unit 20 may be configured to receive and identify each of the RF pulses 16. The collar unit 20 expects a periodic signal 16 to be received; in an exemplary embodiment, a signal is expected every 0.5 second, but the time period could vary depending on the situation.

In exemplary embodiments, the signals 16 have different power levels, and they travel different distances depending on their power levels. More particularly, the power of the transmitted pulse or signal 16 is adjustable. In an exemplary embodiment, there are four power levels, but embodiments could be comprised of a different combination of levels. Exemplary levels comprise a high-power level, a medium-power level, a low-power level, and a minimum power level. Alternatively, the system could have three levels, i.e., a high-power level, a medium-power level, and a low-power level. As described in more detail herein, the system determines a distance between the collar unit 20 and the control unit 10 by determining which of the signals 16 of different power levels are received by the collar unit 20.

In one example, the high-power signal or pulse 16d travels a distance of up to about 500 feet, or between about 200 and 500 feet. The medium-power signal or pulse 16c travels a distance of up to about 200 feet, or between about 100 and 200 feet. The low-power signal or pulse 16b travels up to about 100 feet or a distance of about 100-200 feet. The minimum-power signal or pulse 16a travels up to about 20 feet. Correspondingly, the collar unit 20, by its receiver 14, is capable of receiving the high-power signal 16d when the distance between the control/base unit 10, with its transmitter 12, and the collar unit 12 is up to about 500 feet. When the distance between the base unit 10 and collar unit 12 is up to about 200 feet, the receiver 14 in the collar unit 20 is capable of receiving the medium-power pulse 16c. The receiver 14 in the collar unit 20 is capable of receiving the low-power pulse 16b when the distance between the control unit 10 and the collar unit 20 is up to about 100 feet, and the receiver 14 in the collar unit 20 is capable of receiving the minimum-power pulse 16a when the distance between the control unit 10 and the collar unit 20 is up to about 20 feet.

The signals of varying strength and power levels create zones centered around the control/base unit 10 in which the collar unit 20 is able to operate without emitting the warning tone. As discussed in more detail herein, if the dog being monitored exceeds a particular zone the collar unit 20 may emit a warning tone or buzz 24. This Mobile Zone Control (MZC) system can be an incredibly valuable system for dog owners, as described herein.

In exemplary embodiments, the collar unit 20 transmits an acknowledge (ACK) signal 18 to the control/base unit 10 each time it receives a signal 16. In exemplary embodiments, the collar unit 20 transmits using a power level above the max (high-power) transmission power level so that the base unit 10 is able to receive the transmission even if the collar unit 20 is out of the max zone. If the collar unit 20 does not detect the presence of the expected transmission signal 16, it will send a negative-acknowledge (NACK) to the BASE. If the BASE receives a NACK, it will alert the user that the COLLAR is out of range.

The return signal from the collar unit 20 may vary depending on the signal that is received, i.e., if the collar unit 20 receives the minimum-power signal 16a from the control unit 10, it sends a first return signal. If the collar unit 20 receives the low-power signal 16b (but not the minimum-power signal), it sends a second return signal, etc. This is one way that the system 1 determines whether the collar unit 20, and by extension, the dog, is at a close distance, medium distance, or long distance from the control unit 10, which is with the person.

Exemplary embodiments operate on the presence (or absence) of an expected signal; they can operate with or without Received Signal Strength Indications (RSSI). If the receiver 14 with the collar unit 20 does not receive an expected signal 16 within a pre-determined time period, a clock 22 is started. If the clock 22 as it is counting reaches a predetermined value or time period without receiving the expected signal, an audible warning tone is emitted on the collar unit 20. In exemplary embodiments, the predetermined value is 2.5 s (or 5 missed signals), but other time values could be utilized. Once a signal 16 with the correct encoding is received by the receiver 14 with the collar unit 20, the clock 22 is reset.

Dog collar units 20 equipped with exemplary embodiments of an MZC system can include a “locate” feature. When a dog “breaks,” passing through the MZC system beyond a maximum allowable distance, and the owner cannot be clear on where the dog is, the owner can activate an audio feature. By doing so, the dog's collar unit 20 will emit an audio sound 24 that enhances the owner's ability to track dog location and find the dog. This could occur right after a “shot” on a bird, when the dog is doing its best to find the bird, and ultimately, to retrieve the bird. This audio signal would replace the strident tone signal. When it is turned on, it replaces the strident tone signal.

It should be noted that in such settings the owner would not want to negatively influence the dog. The owner wants the dog to go to almost any length to find the crippled bird. The onus is on the owner. The owner needs to track where the dog is and can do so via audio signal 24. When the dog breaks through the MZC radius, the owner is buzzed, and alerted to the fact that the canine is outside of the prescribed zone. By activating the audio signal 24, the owner has a new ability to find the dog, even in heavy cover.

Various types of audio signals could be used. In a hunt scenario the audio signal could be a hawk sound, which also helps to keep birds still, and on the ground. Numerous variations of this theme are also possible. An example could be a voice recorded message for a companion dog. Something like “Hi, I'm Reacher. My owner, Bruce Kania, seems to have gotten lost! His phone number is ______,” or “Hi, I'm Reacher, and I wouldn't mind half of a ham sandwich right about now! My owner will gladly pay for the sandwich. He's reachable at ______.” Such a message might replay once a minute, while batteries last. Giving people a phone number without them having to catch the dog, or even approach the dog too closely, could help many dogs find their way home again.

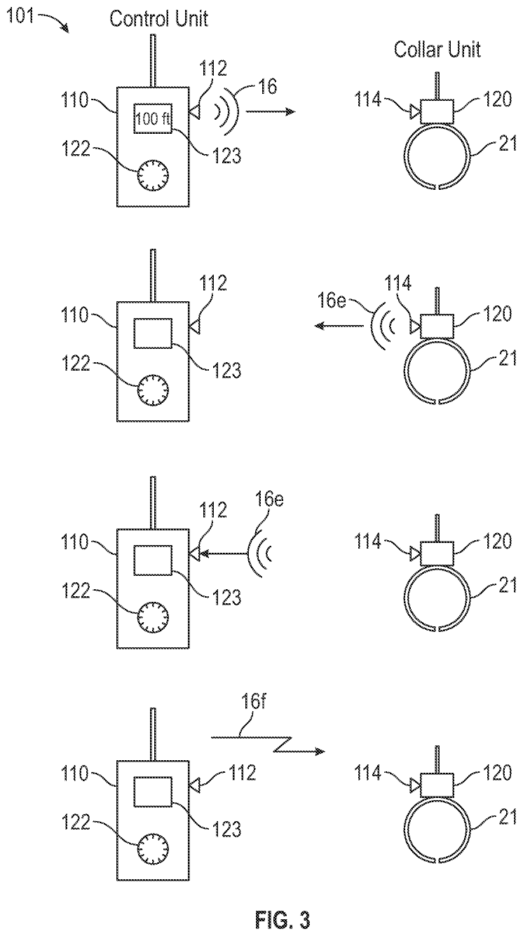

Turning to FIG. 3, systems that determine the distance between a dog and person by measuring signal travel time will now be described. In exemplary embodiments, the system 101 computes the distance between the control unit 110 carried by the person and the collar unit 120 worn by the dog by measuring the time it takes for signals 16 to travel between the control unit 110 and the collar unit 120. The control unit 110 includes a transmitter 112, which may be housed within the control unit or coupled thereto, and the collar unit 120 includes a corresponding receiver 114 located within the collar unit 120 or coupled to it.

The control unit 110 transmits an ultrasonic or RF signal 16 and starts an internal clock 122. The collar unit 120 receives the ultrasonic signal 16 and the control unit 110 transmits an ultrasonic or RF signal 16 back to the control unit 110. The control unit 110 receives the return signal 16e from the collar unit 120 and computes the transit time for the control unit signal 16 plus the return signal 16e and calculates the distance between the two units 110, 120 based on the travel time computation. In exemplary embodiments, the control unit 110 displays visual or audible distance information and transmits a reply signal 16f, which could be a “good distance” signal, a warning signal, or a correction signal to the collar unit 120, depending on the calculated distance between the two units 110, 120. The collar unit 120 may provide a “good distance” tone, a warning tone, or a shock to the dog depending on the distance.

In an embodiment, the system 101 computes the distance between the control unit 110 carried by the person and the collar unit 120 worn by the dog by measuring the one-way travel time of ultrasonic pulses 16 that travel from the control unit 110 to the collar unit 120. The collar unit 120 comprises a radio transmitter 114 that sends a return radio signal 16e from the collar unit 120 to the control unit 110 when the collar unit 120 receives and recognizes the ultrasonic signal 16 from the control unit 110. An internal clock 122 in the control unit 110 measures the elapsed time between the transmission of an ultrasonic pulse 16 from the control unit 110 to the reception of a return radio signal 16e from the collar unit 120.

As mentioned above, in another embodiment the system 101 measures two-way travel time of signals 16, 16e that travel from the control unit 110 to the collar unit 120, and back from the collar unit to the control unit. Referring again to FIG. 2, exemplary two-way dog monitoring systems work as follows. The control unit 110 and the collar unit 120 each comprise an ultrasonic pulse transmitter 112 and a receiver 114 (second transmitter and receiver not shown). The control unit 110 sends out a short ultrasonic pulse 16 at a first frequency that has a higher frequency than the upper limit of hearing for a dog (e.g., 80 kHz). A clock 122 starts in the control unit 110 when the pulse 16 is sent. The collar unit 120 receives and recognizes the ultrasonic pulse 16 from the control unit 110, and immediately sends out a short ultrasonic pulse 16e at a second frequency (e.g., 85 kHz). The control unit 110 receives and recognizes the ultrasonic return pulse 16e sent by the collar unit 120 and measures the elapsed time as measured by the control unit clock 122.

The distance between the control unit 110 and the collar unit 120 is computed by an internal computer in the control unit 110 from the elapsed time (travel time of the two pulses) and the known speed of sound in air. The control unit 110 compares the calculated distance to a preset “maximum allowable distance” that the user has programmed into the control unit 110. If the calculated distance exceeds the maximum allowable distance, an optional correction signal 16f may automatically be sent from the control unit 110 to the collar unit 120. The correction signal 16f may be an audible tone, a vibration, an electrical shock, or other signal that the dog can perceive. In exemplary embodiments, a display 123 on the control unit 110 shows the present distance from the control unit 110 to the collar unit 120.

The ultrasonic pulses 16 from the control unit 110 are resent at a preset interval (e.g., 2 seconds) to provide a continuous readout of the calculated distances between the units 110, 210. The ultrasonic pulses 16 from the control unit 110 can be coded so that only collar units 120 that are linked to that control unit 110 will respond to these pulses. The collar unit pulses 16e can be coded so that the control unit 110 can work with multiple collar units simultaneously. The pulse coding could be achieved by using specific frequencies (e.g., 80.45 kHz), or by sending a combination of pulses (e.g., 3 short and 3 long pulses), or by other coding techniques. Exemplary embodiments utilizing ultrasound signals for distance confirmation would ideally operate at frequencies that humans, dogs and birds cannot hear, and that do not impact them in any discernable way. In exemplary embodiments, that range could be from 1 Hz to 128 kHz, but would vary depending on the animal and species and would be known to one of skill in the art.

If required, the travel time calculation can be corrected for variations in the speed of sound due to air temperature or elevation, using sensors in the control unit 10, 110. Accuracy is in the range of 1 foot, compared to standard GPS-type devices, which have an accuracy of about 30 feet or more. In exemplary embodiments, the calculation is based on sonic travel time rather than signal strength, so the calculation is not affected by varying signal strength (e.g., weaker signals when the dog goes into a gully, etc.).

The user can preset different distance ranges in the control unit 10, 110. For example, a “heel zone” can extend a short distance from the person, e.g., 0 to 10 feet from the person, an “optimal hunting zone” can extend a moderate distance from the person, e.g., 10 feet to 75 feet from the user, a “warning zone” can extend a larger distance from the person, e.g., 75 feet to 120 feet from the user, and an “out of bounds zone” can cover very distances in excess of, e.g., 120 feet from the person. Various intermittent audible tones produced by the collar unit 20, 120 can be used to advise the dog as to which zone he is in, and the dog will learn to respond to these audible signals in order to avoid an electrical shock correction. The collar unit 20, 120 can also provide positive reinforcement signals when the dog is within the designated zone, or returning from outside the zone, which facilitates the dog's understanding of the boundary designation. The control unit 10, 110 can emit light of different colors or audible tones of different frequencies or vibratory signals to notify the person of the distance to the dog.

In another exemplary embodiment, the control unit 10, 110 and the collar unit 20, 120 is each equipped with a GPS receiver, and the location of the collar unit 20, 210 is periodically transmitted to the control unit 10, 110 via an RF signal 16. A computer in the control unit 10, 110 calculates the distance between the two units 10, 110, 20, 120, and appropriate signals (happy, warning, correction, etc.) are sent from the control unit 10, 110 to the collar unit 20, 120, based on the calculated distance between the two units 10, 110, 20, 120.

In exemplary systems, the radio receiver 14, 114 in the collar unit 20, 120 causes the collar unit 20, 120 to provide audible and electrical shock signals to the dog when desired. The audible warnings 24 and electrical shock corrections sent to the collar unit 20, 120 from the mobile control unit 10, 110 occur automatically, and do not require manual button pushing on the control unit 10, 110, thereby providing “hands-free” operation of the system during normal operation. The automatic warning and correction signals may temporarily be manually canceled when desired. In addition, the warning and correction signals may optionally be automatically suppressed after a gunshot noise is detected by the control unit 10, 110, so that the dog may make a long retrieve of a downed bird without being warned or corrected.

In operation, the person walking her dog or taking the dog hunting puts the collar 21 with the collar unit 20, 120 on the dog and keeps the control or base unit 10, 110 on her person. Once the system 1, 101 is turned on, the control or base unit 10, 110 uses the radio transmitter 12, 112 to send encoded periodic signals 16 to the receiver 14, 114 with the collar unit 20, 120. As discussed above, the signals 16 have different power levels, e.g., a high-power level, a medium-power level, a low-power level, and a minimum power level.

If the collar unit 20, 120 detects all four of the transmitted pulses 16a, 16b, 16c, 16d, then the logic-control system within the collar unit 20, 120 determines that the collar unit 20, 120 is within about 20 feet of the control unit 10, 110. If the collar unit 20, 120 detects the high-power pulse 16d, the medium-power pulse 16c and the low-power pulse 16b, but does not detect the minimum-power pulse 16a, then the logic-control system will determine that the collar unit 20, 120 is between about 20 and about 100 feet of the control unit 10, 110. If the collar unit 20, 120 detects the high-power 16d and medium-power pulses 16c only, then the logic-control system will determine that the collar unit 20, 120 is between about 100 and about 200 feet from the control unit 10, 110. If the collar unit 20, 120 detects the high-power pulse 16d only, then the logic-control system will determine that the collar unit 20, 120 is between about 200 and about 500 feet of the control unit 10, 110.

If none of the pulses is detected, then the circuit will calculate that the collar unit 20, 120 is more than 500 feet from the control unit 10, 110. The user might elect to program the collar unit 20, 120 to provide positive or negative stimulation to the dog wearing the collar unit 20, 120 based on the calculated distance. An optional transmitter in the collar unit 20, 120 can send a signal to a receiver 12, 112 in the control unit 10, 110 to notify the user of the calculated distance.

In a second operating mode, the high-power pulse 16d is used to turn on the receiver 12, 112 in the collar unit 20, 120 and cause it to wait for additional pulses. If no high-power signal 16d is detected, the collar unit 20, 120 assumes that the control unit 10, 110 is not active, and no stimulation is given to the dog. If only the high-power signal 16d is detected, then the logic-control system will determine that the dog is between about 200 and about 500 feet from the control unit 10, 110. If the high-power 16d and medium-power signals 16c only are detected, then the logic-control system will determine that the distance is between about 100 and about 200 feet. If the high 16d, medium 16c, and low-power 16b pulses are detected, then the calculated distance is between about 20 and about 100 feet. If all four of the pulses 16a, 16b, 16c, 16d are detected, then the distance is within about 20 feet or less. An optional transmitter in the collar unit 20, 120 can send a signal 16 to a receiver 12, 112 in the control unit 10, 110 to notify the user of the calculated distance. Positive or negative stimulation can be provided to the dog based on user-set distance preferences.

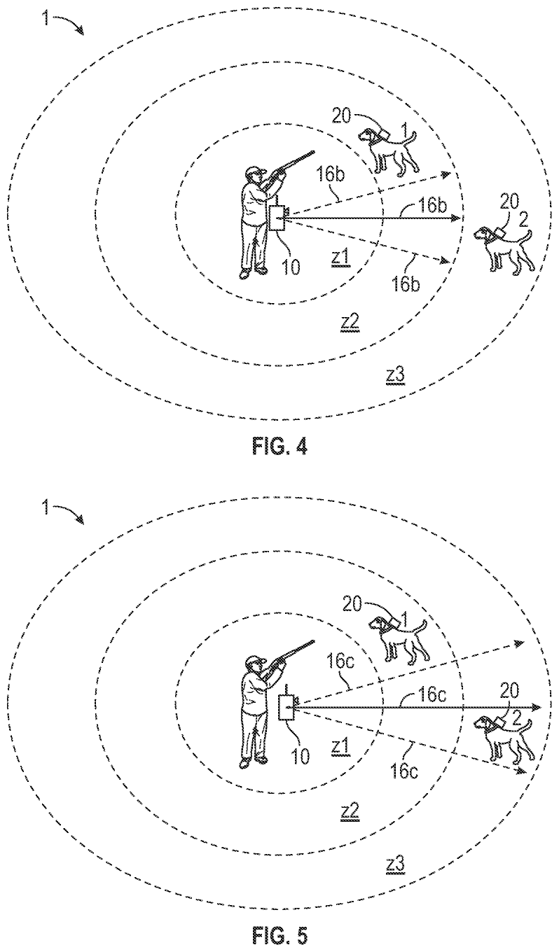

With reference to FIGS. 4-10, examples of dog monitoring systems in operation will be described. FIG. 4 shows zones around the hunter (one embodiment includes three zones, z1-z3) where Dog-1 is in Zone-2 and Dog-2 is in Zone-3. As discussed above, in disclosed embodiments, the base unit has a variable power radio transmitter. In FIG. 4 the base unit 10 has been set to transmit signals 16b at Level-2 power (low power, which corresponds to Zone-2). The radio signal 16b propagates away from the base unit 10, and the collar unit 20 detects whether a radio signal is present; the strength of that signal does not matter. In this example, Dog-1's collar unit 20 detects the signal 16b and does not activate a corrective indicator. By contrast, Dog-2's collar unit 20 is too far away from the base unit 10 to detect any signal and, therefore, activates its corrective indicator. In FIG. 5, the user has increased the transmit power to Level-3, a medium-power signal 16c, which corresponds to Zone-3. Now, both Dog-1 and Dog-2's collar units 20 detect the radio transmission 16c and neither activates its corrective indicators.

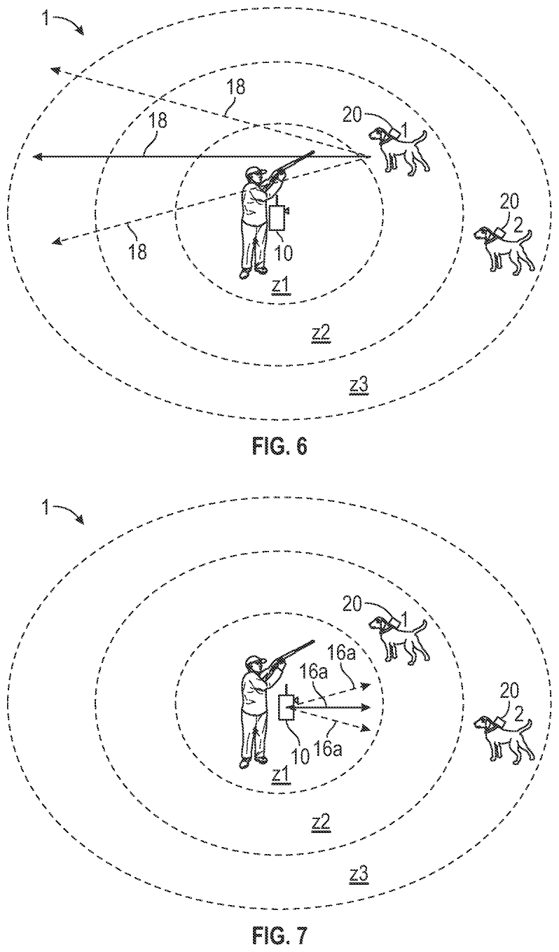

For the user to know whether the dogs are in-bounds, the collar unit 20 sends a signal back to the base unit. FIG. 6 shows the result of the base unit 10 being set at power Level-2 as in FIG. 4. Here Dog-1's collar unit 20 received a transmit signal (not shown) and responded with an acknowledge (ACK) signal 18. Dog-2's collar unit 20 did not receive the signal in this case and therefore did not respond. In exemplary embodiments, ACK signals 18 from each collar unit 20 are coded so the base unit 10 knows Dog-1 was in-bounds and Dog-2 was out-of-bounds. In exemplary embodiments, the ACK signal 18 transmits at power Level-4 so the base unit 10 always receives the ACK signals 18 if they are sent.

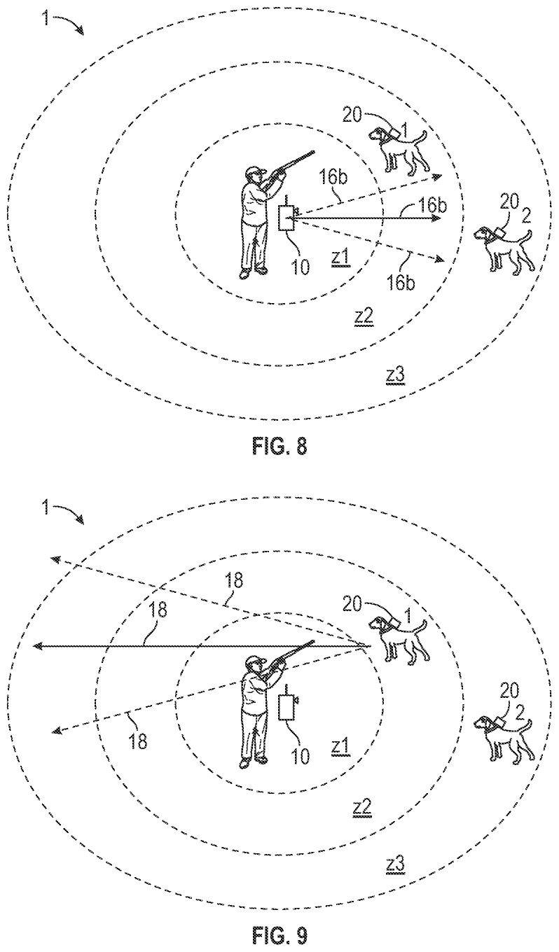

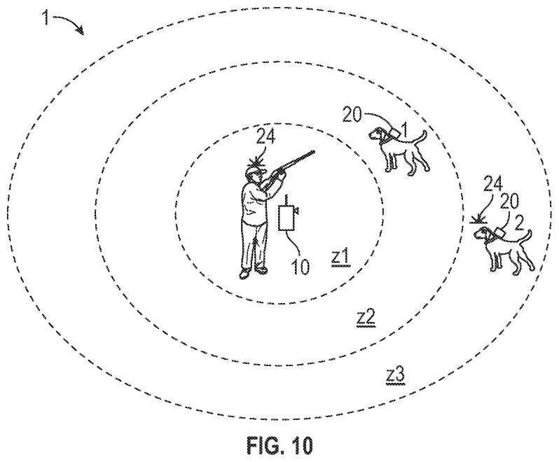

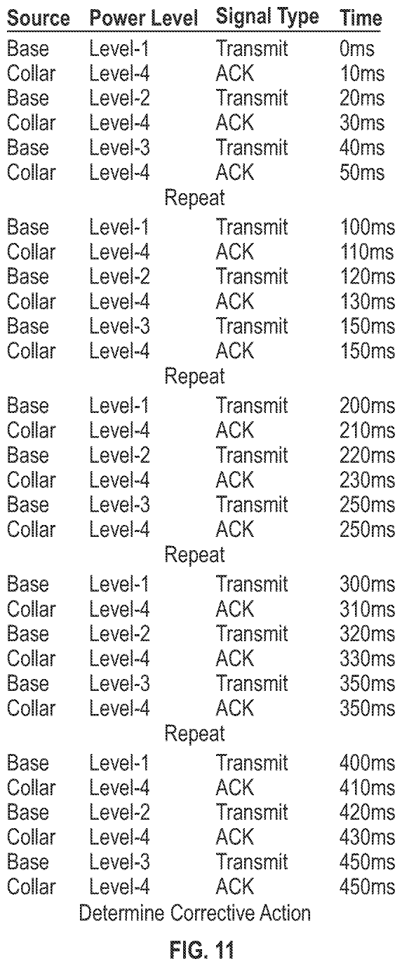

FIGS. 7-10 show an exemplary sequence of transmissions 16, 18. For all these figures the base unit 10 is set to limit the dog's in-bounds area to Zone-2. The action in FIG. 7 occurs at time=0 s and shows a signal 16a transmitting at minimum power, or Level-1. There are no dogs in Zone-1 and nothing happens. FIG. 8 occurs at time=10 ms and shows the signal 16b strength automatically increased to low power, or Level-2. Dog-1 is in Zone-2 and receives the signal 16b. FIG. 9 occurs at time=20 ms and shows that Dog-1's collar unit 20 responded with a power Level-4 ACK signal 18. Dog-1's collar unit 20 knows that it is in bounds and the base unit 10 knows Dog-1 is in Zone-2. Because the base unit 10 was set at Zone-2, the base unit 10 stops transmitting. FIG. 10 occurs at time=0.5 seconds. If after 0.5 seconds Dog-2's collar unit 20 has not received a transmit signal 16a, 16b, it activates its corrective indicator 24, which could be an audio signal. Additionally, if the base unit 10 has not received an ACK signal 18 from Dog-2, it also alerts the user.

To prevent false corrective indications, the transmit pattern is repeated periodically. In exemplary embodiments, the collar unit must miss five consecutive transmissions before assuming it is out-of-bounds, but variations could be used depending on the situation and the needs of the user. FIG. 11 shows the transmission pattern for an exemplary embodiment assuming the base unit is set to Zone-3 (if the base were set to a lower zone, the pattern would omit the higher power levels). Exemplary embodiments could modify the time between transmissions and/or the number of required transmissions.

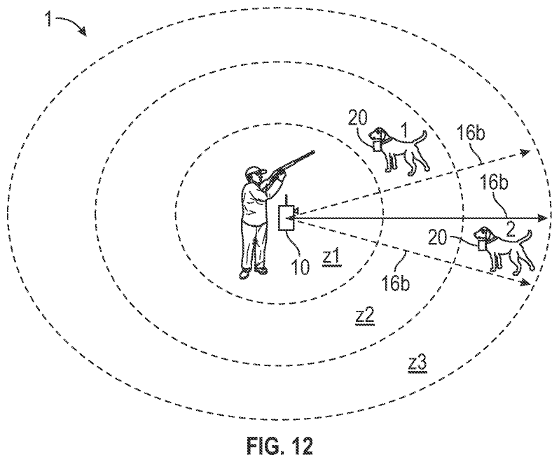

One of the advantages of disclosed embodiments is that they do not require the ability to measure and/or process signal strength. This works on a binary detection scheme. FIG. 12 again assumes the base unit 10 is set for Zone-2, but in this figure Zone-2 is exaggerated for clarity. In this figure both dogs are within Zone-2 and would receive the radio signal 16b.

The dog owner can use this Mobile Zone Control (MZC) system to manage a dog that does not yet focus on reasonable rules of behavior. For example, the owner sets the MZC system for 20 meters. The hike begins. When the canine is within the prescribed zone, it receives a pleasant, positive reinforcement audio signal. When the canine approaches the perimeter of a zone, e.g., ten meters, the canine receives more strident audio tones. Or the canine receives three of the tones in quick succession. When the canine steps out of the zone, the owner receives signal on an arm wrist cuff, alerting the owner. The dog continues to receive strident tones, and now, at the owner's discretion, may also experience a “buzz”, based on a separate conventional control collar.

The dog quickly learns that the strident or three in succession audio sounds may be followed by a “buzz” and will correct by staying within the pleasant audio zone. This means that a correction collar may not always be required. In exemplary embodiments, when the dog exceeds the boundary, the dog may or may not be automatically buzzed. If the dog is not buzzed, instead the owner is signaled. Then the owner can respond at the owner's discretion.

There are many ways the dog owner could use positive reinforcement methods as well as additional factors such as automatic signaling. If a hunting dog breaks while the hunter is distracted, the system automatically signals the dog to stay within the prescribed zone. Similarly, the system could forewarn a hunting dog by pleasantly signaling that he was in the zone and warn him before he runs through the zone perimeter. The dog owner could use signals associated with positive reinforcement, like dog treats, periodically when the dog is within the prescribed zone, to induce the dog to return to the owner. This periodic return to owner for reward technique expedites the preferred figure eight ranging or coursing goal associated with both flushers and pointers.

Some examples of how a dog can be taught what the positive reinforcement and warning signals mean will now be described. The dog owner can use the audio as a positive or neutral signal and the buzzer as negative reinforcement. A distinct audio signal can be used as the “come back” command. The goal is to abbreviate the training time and corresponding “buzz” experience for dogs. The dog owner can utilize a series of recorded sounds copied into an audio transmitter.

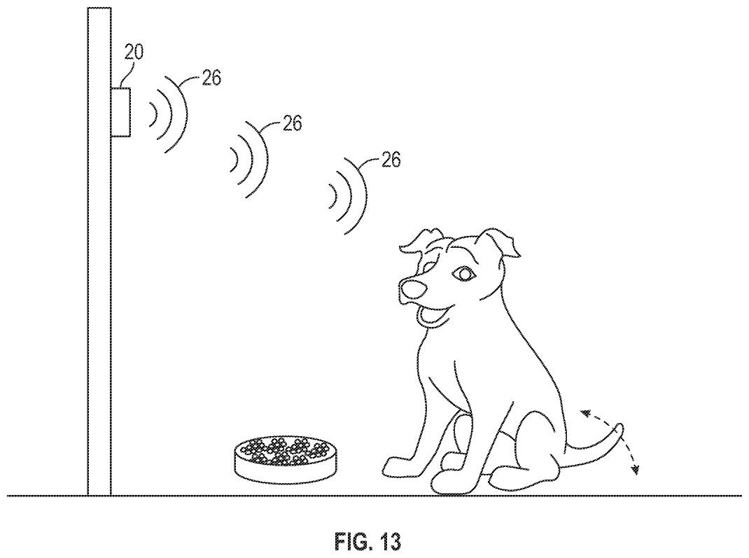

Conditioning a dog to recognize a positive audio sound could be enhanced by having the dog experience the signal in positive settings. As shown in FIG. 13, the collar unit 20 can be plugged into a convenient electrical outlet, near where the dog is fed. More particularly, the MZC collar unit 20 could be activated and placed just above a dog's food dish, so the dog hears the positive tone 26 when dining on a delicious meal. When the dog is eating, the owner presses the large button that activates the signal selected so it plays and is associated with the positive dining experience. Turning the audio tone 26 on during and after the dog's dining experience is best, rather than before the dog starts to eat. Intermittent positive reinforcement is an effective way to reinforce appropriate canine behavior. Accordingly, an owner can pack a pocketful of premier dog treats and, just occasionally when the dog is not distracted and is performing well, reward the dog with treats.

Similarly, when the dog and master are playing a game which the dog really enjoys, like frisbee fetch, the same audio tone can happen. The idea is to incorporate this audio tone around other positive and fun experiences for the dog. Another example is that when the dog is being “praised” the audio tone sounds. The user is targeting “association.” Other examples of when the audio tone can be turned on for positive association include when the dog is contentedly lying on its master's lap, when the dog is being praised for good performance, when the dog is playing a favorite game, like “fetch”, (best to keep the game within the preferred zone control radius), and when dog is in its “safety” zone, like its kennel, crate or bed. The tone should be employed in association with appropriate behavior and safety/security/comfort.

The user can turn on the external “happy” tone to signal other favorite canine experiences. For example, these can include playtime, or the start of a hunt when the trainer is applying the dog's zone control collar. The tone does not have to be employed with every positive experience, just occasionally. Intermittent positive reinforcement is highly effective.

When in the field, the dog hears the pleasant audio tone as long as he is in the zone. When he approaches the zone's perimeter, the tone must change. It can become louder, quieter, and/or more strident. But the “change” is the key, as it informs the dog that the perimeter is near. The next signal, in the event that the dog breaks through the zone barrier, is for the “buzz” to happen. In exemplary embodiments, the buzz can increase in volume or frequency with distance. This could abbreviate training time. A “graduated” system in which the audio tone changes as the dog approaches the zone perimeter or returns from being outside of zone perimeter will expedite the dog's ability to learn the boundaries of the “happy” zone. Being relatively consistent with the radius of the zone will also help.

Some additional examples of how a dog owner can utilize disclosed systems to expedite training via positive reinforcement, including examples of positive reinforcement operant conditioning techniques, are as follows. As a dog approaches the limit of a prescribed distance the dog's collar can automatically emit a known signal that represents “treat,” inducing the dog to return to the trainer. Such training can ultimately help condition the dog to stay within the appropriate zone, and coursing through that zone within a desired radius.

Similarly, activation of the strident or three tone signal can be used to inform the dog of inappropriate behavior. These signals, especially when one is sometimes combined with positive reinforcement, like the premier canine treats, and the other is occasionally accompanied by negative reinforcement, like the buzz from a correction collar, will be well within a dog's learning repertoire, and are relatively quickly learned. One goal is for a correction collar not to be required. A dog should learn to always stay within the prescribed zone. Incorporation of a negative reinforcement “buzz” within the MZC collar is another option. This avoids the need for two collars but would need to be automatically shut down upon the report of a gun, to avoid turning a dog away from a retrieve and bird recovery.

As a dog engages in aberrant behavior, like jumping on another human or dog, the trainer can send a known signal to the dog that competes with the dog's interest in jumping. Pairing this with negative reinforcement can contribute to the process of turning the dog back towards the trainer with a treat. The negative reinforcement can be as simple as the human subjected to the jumping placing the flat of their hand in front of the jumper. When a male dog sniffs another dog's genitals, which can readily lead to canine conflict, trainer can send a known signal to the dog that competes with its interest in “sniffing.” Pairing this with a treat when the dog turns from its inappropriate behavior and returns to the trainer abbreviates the risk of dog conflict and inappropriate behavior.

Automatically acknowledging a dog when it achieves success, for example, when it finds a hidden toy or dummy, by emitting a known and pleasant audio signal, will expedite training around the “fetch” command. Placing a transmitter that issues the pleasant audio signal near the target toy or dummy, triggered by proximity to the dog's collar or manually triggered by the trainer, will expedite fetch training and provide opportunities for positive reinforcement. It should be noted that intermittent positive reinforcement is highly effective. In other words, a dog does not need to experience a treat with every positive action.

It should be acknowledged that a dog sometimes will disregard such a signal, or only return partially. In such settings the owner could use exemplary embodiments to occasionally “buzz” him, and the dog will quickly make the connection that he needs to return to his owner to avoid the “buzz.” When the dog approaches the target zone, up to about 40 yards radius, the owner could issue three audio tones about a half second apart. Then the dog turns and reports, essentially coming to the owner's side. This results in a figure eight configuration of his “range.” It also means that if he flushes a bird within this zone, it is close enough that the owner has a reasonable prospect of downing it. Having the three-tone signal automated is a significant advantage. Having the ability to know when the dog advances past the target zone, even in cover, also is an advantage. Having the option to “turn” him directly with a buzz is an advantage. Having the ability to trigger a relatively loud audio tone signal, that the owner can hear, to locate the dog, is an advantage.

The audio tone signal can emit from a separate device that allows the master to work on dog control every day, and ultimately make appropriate dog behavior a conditioned response. This means that dog field work can readily be brought into the kennel or home. It should also be noted that the system does not need to rely on a separate device to emit the positive tones, but that these can be pre-incorporated into the mobile zone control devices.

Exemplary embodiments allow a dog to graduate into a well-trained, happy dog, as quickly and painlessly as possible. The pleasant audio tone, combined with a changing signal that helps a dog discern that the boundary is approaching and then a distinct and expanding “buzz” if he doesn't respond, will expedite a dog's learning. There is one more signal that can help this process. As the dog returns, the pleasant signal could grow. Advantageously, this combination of positive and negative reinforcement will abbreviate training time. The expanding “buzz” system will go a long way towards keeping a high energy dog within safe range, as compared to a signal that diminishes with distance.

Thus, it is seen that improved systems and methods of dog monitoring and training are provided. It should be understood that any of the foregoing configurations and specialized components or chemical compounds may be interchangeably used with any of the systems of the preceding embodiments. Although illustrative embodiments are described hereinabove, it will be evident to one skilled in the art that various changes and modifications may be made therein without departing from the disclosure. It is intended in the appended claims to cover all such changes and modifications that fall within the true spirit and scope of the disclosure.

While the disclosed systems and devices have been described in terms of what are presently considered to be the most practical exemplary embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A system for monitoring a dog, comprising:
a control unit including a transmitter configured to transmit periodic signals;
a collar unit including a receiver configured to receive the periodic signals from the transmitter;
wherein the periodic signals comprise individual signals having different power levels such that the individual signals travel different distances depending on their respective power levels; and
wherein the system determines a distance between the collar unit and the control unit by determining which of the individual signals are received by the collar unit.

2. The system of claim 1 wherein the different power levels comprise a high-power level, a medium-power level, a low-power level, and a minimum power level.

3. The system of claim 2 wherein the receiver is configured to receive an individual signal having a high-power level when a distance between the control unit and the collar unit is up to about 500 feet, the receiver is configured to receive an individual signal having a medium-power level when a distance between the control unit and the collar unit is up to about 200 feet, the receiver is configured to receive an individual signal having a low-power level when a distance between the control unit and the collar unit is up to about 100 feet, and the receiver is configured to receive an individual signal having a minimum-power level when a distance between the control unit and the collar unit is up to about 20 feet.

4. The system of claim 1 wherein the periodic signals and individual signals are RF pulses.

5. The system of claim 1 wherein when the receiver does not receive a periodic signal within a pre-determined time period the collar unit starts a clock.

6. The system of claim 5 wherein when the clock reaches a pre-determined time value the collar unit emits an audible warning; and
wherein when the receiver receives a periodic signal the collar unit resets the clock.

7. The system of claim 1 further comprising a locate feature causing the collar unit to emit an audible signal.

8. The system of claim 1 wherein the collar unit is coupled to or integrated with a collar configured to be worn by a dog.

9. The system of claim 8 wherein the collar unit provides negative reinforcement when the dog exceeds a pre-determined maximum allowable distance from a person and positive reinforcement when the dog stays within the pre-determined maximum allowable distance from the person.

10. A system for monitoring a distance between a dog and a person, comprising:
a control unit including a transmitter configured to transmit signals;
a collar unit including a receiver configured to receive the signals from the transmitter;
wherein the system determines the distance between the person and the dog by measuring travel time of the signals between the control unit and the collar unit; and
wherein the control unit provides an indication of the distance between the dog and the person.

11. The system of claim 10 wherein the system determines the distance between the person and the dog by measuring one-way travel time of the signals traveling from the control unit to the collar unit.

12. The system of claim 10 wherein the system determines the distance between the person and the dog by measuring two-way travel time of the signals traveling from the control unit to the collar unit and back from the collar unit to the control unit.

13. The system of claim 10 wherein the collar unit is coupled to or integrated with a collar configured to be worn by a dog.

14. The system of claim 13 wherein the collar unit provides negative reinforcement when the dog exceeds a pre-determined maximum allowable distance from a person and positive reinforcement when the dog stays within the pre-determined maximum allowable distance from the person.

15. A method of monitoring a dog, comprising:
transmitting a series of periodic signals from a base unit, including one or more of: a high-power signal traveling a first distance, a medium-power signal traveling a second distance shorter than the first distance, a low-power signal traveling a third distance shorter than the second distance, and a minimum-power signal traveling a fourth distance shorter than the third distance;
receiving the periodic signals in a dog collar unit; and
determining the distance between the dog collar unit and the base unit by determining which of the high-power signal, medium-power signal, low-power signal, and minimum-power signal is received by the dog collar unit.

16. The method of claim 15 further comprising:
determining that the distance between the dog collar unit and the base unit is between about 200 feet and about 500 feet when only the high-power signal is received by the dog collar unit, determining that the distance between the dog collar unit and the base unit is between about 100 feet and about 200 feet when only the high-power signal and medium-power signal are received by the dog collar unit, determining that the distance between the dog collar unit and the base unit is between about 20 feet and about 100 feet when only the high-power signal, medium-power signal, and low-power signal are received by the dog collar unit, and determining that the distance between the dog collar unit and the base unit is less than about 20 feet when the high-power signal, medium-power signal, low-power signal and minimum-power signal are received by the dog collar unit.

17. The method of claim 15 further comprising transmitting an acknowledgement signal from the dog collar unit to the base unit each time the dog collar unit receives a signal from the base unit.

18. The method of claim 15 wherein the dog collar unit provides negative reinforcement when the dog exceeds a pre-determined maximum allowable distance from a person and positive reinforcement when the dog stays within the pre-determined maximum allowable distance from the person.

19. The method of claim 15 further comprising starting a clock when the dog collar unit does not receive a signal within a pre-determined time period.

20. The method of claim 19 further comprising emitting an audible warning when the clock reaches a pre-determined time value; and
resetting the clock when the dog collar unit receives a periodic signal.
